(19) United States
(12) Patent Application Publication
(10) Pub. No.: US 2023/0319226 A1
(43) Pub. Date: Oct. 5, 2023

(54) System For Providing Dynamic Backgrounds In Live-Action Videography

(71) Applicant: Rosco Laboratories Inc., Stamford, CT (US)

(72) Inventor: Mark Engel, Stamford, CT (US)

(21) Appl. No.: 18/193,162

(22) Filed: Mar. 30, 2023

Related U.S. Application Data
(60) Provisional application No. 63/327,094, filed on Apr. 4, 2022.

(51) Int. Cl. H04N 5/272; G06T 7/194

(52) U.S. Cl. CPC H04N 5/272; G06T 7/194; G06T 2207/10016

(57) ABSTRACT

A system for providing dynamic backgrounds in live-action videography is disclosed having a camera for recording live-action video, a display wall, situated within a line of sight of the camera, for displaying a background, a database of images for displaying on the display wall, a computer in data communication with the database and the display wall, a mobile device for providing inputs to the computer, the mobile device configured to present a list of the images in the database for selection for display on the display wall, the computer receiving a selection of one of the images, the display wall displaying the selected image, the mobile device configured to present a list of modifications for the selected image, the modification altering the appearance of the image on the display wall, the computer receiving a selection of a modification, the computer processing the selected modification to the image to generate a background, and the display wall displaying the background.

### TECHNICAL FIELD

The present invention relates to a providing dynamic backgrounds in live-action videography.

### BACKGROUND

Traditional film and stage productions use large canvas backdrops to provide backgrounds. Such backgrounds are typically either selected from a library of pre-existing backdrops, or are custom made for a production. The custom process typically includes sending a team to take photographs of a location and printing such photograph on the canvas background. However, this process takes time and the canvas backdrop cannot be changed after it is made. In addition, the canvas backdrop can only be used for a single production at a time.

Moreover, modern CGI or static digital backgrounds may solve issues associated with making and replicating images on analog backdrops. However, multiple versions of the same background may be needed. For example, a day and a night background of the same background may be required.

In addition, because static digital backgrounds are static, no changes can be made at the time of shooting. This leads to decreased control for directors, producers, and all involved.

### SUMMARY

For these and other reasons known to a person of an ordinary skill in the art, what is needed is a system for providing dynamic backgrounds in live-action videography.

Another goal of the present invention is to display dynamic, high-resolution images on a display wall.

Another goal of the present invention is to allow on-set, user-directed modification of the image displayed on the display wall, or a portion thereof.

Another goal of the present invention is to allow modification of the image displayed based on a display wall based on on-set lighting and color conditions.

Another goal of the present invention is to allow a portion of the image displayed display wall to change based on a movement vector or view vector of a camera.

In one aspect of the present invention, a system for providing dynamic backgrounds in live-action videography is disclosed having a camera for recording live-action video and a display wall, situated within a line of sight of the camera, for displaying a background. A database of images for displaying on the display wall is provided along with a computer in data communication with said database and said display wall. A mobile device for providing inputs to said computer is provided, the mobile device configured to present a list of the images in the database for selection for display on the display wall. The computer receives a selection of one of the images and the display wall displaying the selected image. The mobile device is configured to present a list of modifications for the selected image, the modification altering the appearance of the image on the display wall. The computer receives a selection of a modification and the computer processes the selected modification to the image to generate a background. The display wall displays the background.

### BRIEF DESCRIPTION OF THE DRAWINGS

FIG. 1 shows a schematic diagram of the system described in the claims.

### DETAILED DESCRIPTION

The present invention will now be described by referencing the appended FIGURE.

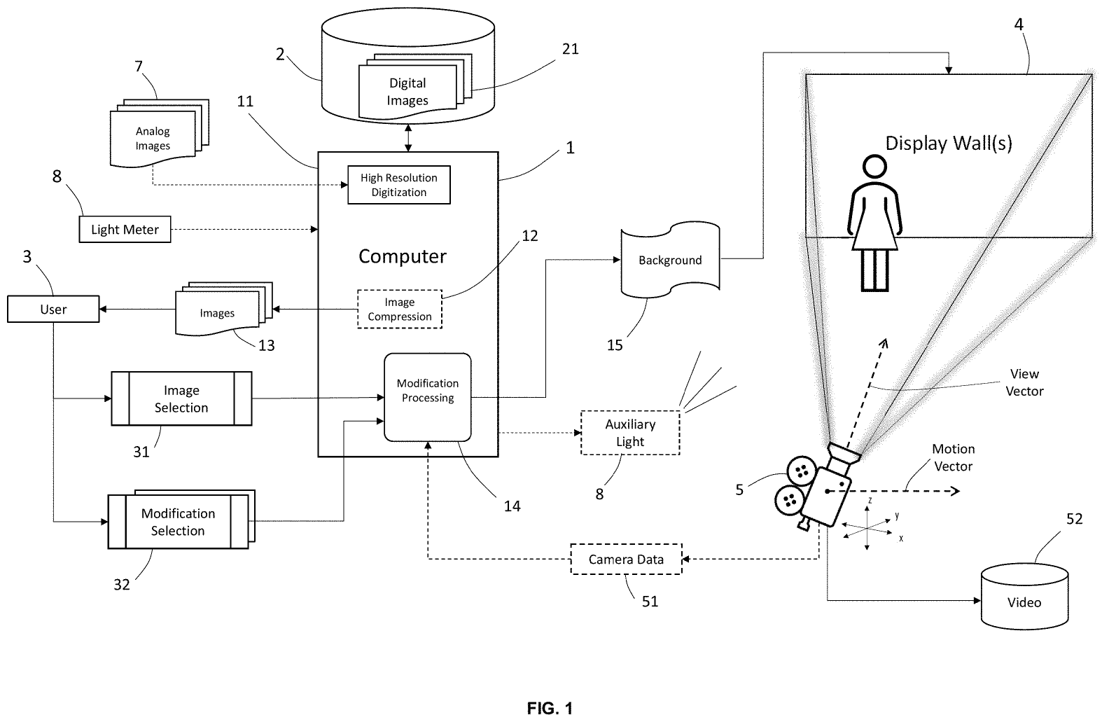

Referring to FIG. 1, the present disclosure describes a system 10 for providing dynamic backgrounds in live action videography.

The system 10 includes a computer 1, a database 2, a user device 3, a display wall 4, and a camera 5.

The computer 1 may be a server, computer, laptop, smartphone, tablet, vehicle, or other electronic device. The computer 1 may include a processor, computer, remote computer, computer server, network, or any other computing resource.

A database 2 is in data communication with the computer 1. Database 2 may include high- or low-resolution video files, layered 2D images and/or flat 2D images. Generally, the images are photo real and not computer generated or illustrations. Database 2 also includes digital images 21. Digital images 21 may be high-resolution images.

One or more of the digital images 21 may be video. Alternatively or in addition, the database may include images 21 that are digitized versions of analog images or digitized versions of analog backdrops. The database may be any type of hardware that is used to store images and other information. The database 2 may be integrated in the computer 1, or may be cloud-based.

The computer 1 may include software 11 for creating high-resolution digitization of analog images 7. The computer 2 may save the digitized images in the database 2.

The computer 1 may include software 12 for compressing images. The compression 12 may take a digital image 21 or a digitized analog image and export a lower resolution image 13. The lower resolution image 13 may be provided to a user device 3.

The user device 3 may be a server, computer, laptop, smartphone, tablet, vehicle, or other electronic device. The user device 3 may include a processor, computer, remote computer, computer server, network, or any other computing resource. The user device 3 may be a tablet computer with a touch screen interface.

A display wall 4 which may also be provided as a screen projector is provided in data communication with said computer 1. The display wall 4 may be LED-based, but can use any display technology that allows for dynamic high-resolution images. The display wall 4 may be configured to display high resolution digital images.

A camera 5 is provided, most preferably a video camera. The camera may provide camera data 51 to the computer 1. The camera 5 may have a motion vector (depending on how it is mounted and actuated) and will have a view vector. The camera data 51 may include information regarding the motion vector, view vector, position, angle, line of sight, resolution, color settings, exposure, aperture, depth of focus, zoom level, other image settings of the camera, or other known features to the computer 1. The camera 5 may generate a video 52. The video 52 may be on film or digital. The video 52 may be stored in a database, such as database 2.

While shooting a scene, a viewing angle of the camera 5 may face the display wall 4. At least one actor or other physical foreground element may be between the camera 5 and the display wall 4.

The user device 3 is provided with a list of images 13 that may be displayed as a background 15 on the display wall 4. The images 13 may be low resolution, or compressed before sending to the user device 3. Alternatively, high resolution images 13 may be provided to the user device 3. The user device 3 may provide a selection of an image to the computer 1.

The user device 3 presents a list of modifications that can be made to the images 13 before or while it is displayed on the display wall 4. The list of modifications may be presented in any known manner, such as through menus, submenus, using sliders, pick lists, etc. The list of modifications may be provided to the user device 3, in some cases by the computer 1. The list of modifications may be stored in the database 2. The user device 3 may select a modification and provide the modification selection 32 to the computer 1. The selected modification may include a selection of the portion of the background to which the modification will apply.

The selected modification 32 the computer 1 processes 14 may be at least one or more of the following: (1) changes to the apparent time of day of the background, (2) pans, tilts, positions, or zooms to at least a portion of the background, (3) changes to the shape, exposure, color temperature, spotlight, of the background, (4) defocuses or focuses of at least a portion of the background, or (5) additions or subtractions of fog or atmospheric effects.

The selected modification 32 may insert a chromakey on at least a portion of the background for later use in post-video processing. The selected modification 32 may also insert images of other objects over at least a portion of the background, which can include dynamic images and/or added effects.

The computer 1 may process the selected modification 32 using software. The software may include standard off-the-shelf libraries or engines. The software may include the Unreal Engine or other known graphics engines, or may be provided as custom/proprietary software.

The computer 1 may process 14 the selected image 31 and the modification selection 14 to generate a background 15. The portion of the background 15 may be displayed on the display wall 4 in real-time with the selection of the modification. Alternatively, the computer 1 may save the generated background 15 for later use, preferably in the database 2.

Camera data 51 may also be included in the process 14 of generating the background 15. For instance, camera data 51 may be used to limit the processing 14 to a portion of the display wall 4 that is or will be in a view vector of the camera 5. The computer may receive and use a motion vector or a view vector of the camera 5 in this modification. For example, the modification may adjust the background to maintain a consistent apparent distance between the background and the camera 5.

A light meter 9 may also be in data communication with said computer 1. The light meter 9 may provide information regarding lighting and/or color of the video wall. The computer 1 may process the information provided by the light meter 9 and adjust the background 15 during the process 14.

At least one auxiliary light 8 which may be provided as an auxiliary LED panel/wall may also be used in the system. The auxiliary light 8 may be a stage light. The auxiliary light 8 may be LED-based. The auxiliary light 8 may be a white light capable of at least one-color temperature, or a color light capable of at least one color. The auxiliary light 8 may be positioned outside a line of sight of the camera. The auxiliary light 8 may be positioned so that it shines on the display wall or in an area between the display wall and the camera.

The auxiliary light 8 may be controllable by the computer 1 or the user device 3. The computer 1 or the user device 3 may control the auxiliary light 8. The computer 1 or the user device 3 may control the type of light emitted by the auxiliary light 8, such as the color or color temperature of the light.

The computer 1 or the user device 3 may control the auxiliary light 8 such that light emitted by the auxiliary light 8 matches or complements light from the display wall. This may be part of the process 14.

In compliance with the statute, the present teachings have been described in language more or less specific as to structural and methodical features. It is to be understood, however, that the present teachings are not limited to the specific features shown and described, since the systems and methods herein disclosed comprise preferred forms of putting the present teachings into effect. The present disclosure is to be considered as an example of the invention, and is not intended to limit the invention to a specific embodiment illustrated by the figures above or description below.

For purposes of explanation and not limitation, specific details are set forth such as particular architectures, interfaces, techniques, etc. in order to provide a thorough understanding. In other instances, detailed descriptions of well-known devices, circuits, and methods are omitted so as not to obscure the description with unnecessary detail.

Generally, all terms used in the claims are to be interpreted according to their ordinary meaning in the technical field, unless explicitly defined otherwise herein. All references to a/an/the element, apparatus, component, means, step, etc. are to be interpreted openly as referring to at least one instance of the element, apparatus, component, means, step, etc., unless explicitly stated otherwise. The steps of any method disclosed herein do not have to be performed in the exact order disclosed, unless explicitly stated. The use of “first”, “second,” etc. for different features/components of the present disclosure are only intended to distinguish the features/components from other similar features/components and not to impart any order or hierarchy to the features/components. As used herein, the term “and/or” includes any and all combinations of one or more of the associated listed items. As used herein, the term “application” is intended to be interchangeable with the term “invention”, unless context clearly indicates otherwise.

To aid the Patent Office and any readers of any patent issued on this application in interpreting the claims appended hereto, Applicant that it does not intend any of the claims or claim elements to invoke 35 U.S.C. 112(f) unless the words “means for” or “step for” are explicitly used in the particular claim.

While the present teachings have been described above in terms of specific embodiments, it is to be understood that they are not limited to these disclosed embodiments. Many modifications and other embodiments will come to mind to those skilled in the art to which this pertains, and which are intended to be and are covered by both this disclosure and the appended claims. It is intended that the scope of the present teachings should be determined by proper interpretation and construction of the appended claims and their legal equivalents, as understood by those of skill in the art relying upon the disclosure in this specification and the attached drawings. In describing the invention, it will be understood that a number of techniques and steps are disclosed. Each of these has individual benefits and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

What is claimed:

1. A system for providing dynamic backgrounds in live-action videography, comprising:
a camera for recording live-action video;
a display wall, situated within a line of sight of the camera, for displaying a background;
a database of images for displaying on the display wall;
a computer in data communication with said database and said display wall;
a mobile device for providing inputs to said computer;
the mobile device configured to present a list of the images in the database for selection for display on the display wall;
the computer receiving a selection of one of the images;
the display wall displaying the selected image;
the mobile device configured to present a list of modifications for the selected image, the modification altering the appearance of the image on the display wall;
the computer receiving a selection of a modification;
the computer processing the selected modification to the image to generate a background;
the display wall displaying the background.

2. The system of claim 1 wherein said database of images further comprises digitized versions of analog backdrops.

3. The system of claim 1, wherein at least one of the images is a video.

4. The system of claim 1, wherein at least a portion of the background is displayed on the display wall in real-time with the selected modification.

5. The system of claim 1, wherein the modification changes the apparent time of day of the background.

6. The system of claim 1, wherein the modification pans, tilts, positions, or zooms at least a portion of the background.

7. The system of claim 1, wherein the modification changes the shape, exposure, color temperature, spotlight, of the background.

8. The system of claim 1, wherein the modification defocuses or focuses at least a portion of the background.

9. The system of claim 1, wherein the modification adds fog or atmospheric effects.

10. The system of claim 1, wherein the modification inserts a chromakey over at least a portion of the background.

11. The system of claim 1, further comprising:
a LED light source positioned outside a line of sight of the camera;
the LED light source configured to emit light in a direction toward the display wall.

12. The system of claim 11, the mobile device configured to control the LED light source.

13. The system of claim 1 further comprising a light meter and wherein said computer receives color modification instructions from said light meter.

14. The system of claim 1, wherein the mobile device is configured to allow selection of a portion of the background.

15. The system of claim 1, wherein the mobile device is configured to allow selection of a portion of the display wall.

16. The system of claim 1, the mobile device sending a command to the LED light source to match the color of the LED light source to the portion of the background.

17. The system of claim 1, wherein said camera is in data communication with said computer, and wherein said computer receives information regarding a position of said camera.

18. The system of claim 17 wherein said computer receives information regarding a view vector of said camera.

19. The system of claim 17 wherein said computer receives information regarding a motion vector of the camera.

20. The system of claim 17 wherein said computer adjusts the background to maintain a consistent apparent distance to the camera.

21. The system of claim 1, wherein said computer receives information from said camera regarding exposure, aperture, depth of focus, zoom and other image settings of the camera.

22. The system of claim 1, wherein the modification inserts a dynamic image over at least a portion of the background.

23. The system of claim 1, further comprising an actor between the camera and the display wall.

24. A video production containing imagery generated by a system comprising:
a camera for recording live-action video;
a display wall, situated within a line of sight of the camera, for displaying a background;
a database of images for displaying on the display wall;
a computer in data communication with said database and said display wall;
a mobile device for providing inputs to said computer;
the mobile device configured to present a list of the images in the database for selection for display on the display wall;
the computer receiving a selection of one of the images;
the display wall displaying the selected image;
the mobile device configured to present a list of modifications for the selected image, the modification altering the appearance of the image on the display wall;
the computer receiving a selection of a modification;
the computer processing the selected modification to the image to generate a background;
the display wall displaying the background.

25. The video production of claim 24, wherein said database of images further comprises digitized versions of analog backdrops.

26. The video production of claim 24, wherein at least one of the images is a video.

27. The video production of claim 24, wherein at least a portion of the background is displayed on the display wall in real-time with the selected modification.

28. The video production of claim 24, wherein the modification changes the apparent time of day of the background.

29. The video production of claim 24, wherein the modification pans, tilts, positions, or zooms at least a portion of the background.

30. The video production of claim 24, wherein the modification changes the shape, exposure, color temperature, spotlight, of the background.

31. The video production of claim 24, wherein the modification defocuses or focuses at least a portion of the background.

32. The video production of claim 24, wherein the modification adds fog or atmospheric effects.

33. The video production of claim 24, wherein the modification inserts a chromakey over at least a portion of the background.

34. The video production of claim 24, further comprising:
a LED light source positioned outside a line of sight of the camera;
the LED light source configured to emit light in a direction toward the display wall or between the display wall and the camera.

35. The video production of claim 34, the mobile device configured to control the LED light source.

36. The video production of claim 24 further comprising a light meter and wherein said computer receives color modification instructions from said light meter.

37. The video production of claim 24, wherein the mobile device is configured to allow selection of a portion of the background.

38. The system of claim 24, wherein the mobile device is configured to allow selection of a portion of the display wall.

39. The video production of claim 24, the mobile device sending a command to the LED light source to match the color of the LED light source to the portion of the background.

40. The video production of claim 24, wherein said camera is in data communication with said computer, and wherein said computer receives information regarding a position of said camera.

41. The video production of claim 40, wherein said computer receives information regarding a view vector of said camera.

42. The video production of claim 40, wherein said computer receives information regarding a motion vector of the camera.

43. The video production of claim 40, wherein said computer adjusts the background to maintain a consistent apparent distance to the camera.

44. The video production of claim 24, wherein said computer receives information from said camera regarding exposure, aperture, depth of focus, zoom and other image settings of the camera.

45. The video production of claim 24, wherein the modification inserts a dynamic image over at least a portion of the background.

46. The video production of claim 24, further comprising an actor between the camera and the display wall.

47. A live-action videography system comprising:
a camera for recording live-action video;
a display wall, situated within a line of sight of said camera for displaying a background;
an image selected for the display wall;
a computer in data communication with said display wall;
a program executing on said computer to modify said image to create the background for display on said wall; and
a physical foreground element for live-action between said camera and said display wall.

48. The videography system of claim 48 wherein the camera is mounted for motion relative to said display wall.

49. The videography system of claim 48 wherein said program causes modification of the background during recording by said camera.
